(19) United States
(12) Patent Application Publication
(10) Pub. No.: US 2016/0187996 A1
(43) Pub. Date: Jun. 30, 2016

(54) Apparatus and methods for image/sensory processing to control computer operations

(71) Applicant: Brent A. Safer, Elizabeth, CO (US)

(72) Inventor: Brent A. Safer, Elizabeth, CO (US)

(21) Appl. No.: 14/998,491

(22) Filed: Jan. 11, 2016

Related U.S. Application Data
(63) Continuation of application No. 13/694,465, filed on Dec. 5, 2012, now abandoned.

(51) Int. Cl. G06F 3/01; G06F 3/0484; G06F 3/00

(52) U.S. Cl. CPC G06F 3/017; G06F 3/005; G06F 3/04842

(57) ABSTRACT

Apparatus and methods are disclosed for image and sensory processing to facilitate human interface at a computer terminal. The apparatus include a video camera adapted to capture images of user finger movement above the keyboard primarily in an image plane along X and Y axes substantially normal to the keyboard key-field plane, at least one thumb touch pad segment, and a controller. The methods included capturing the video images of user finger movement in the image plane, capturing user initiated sensory input indicative of selected functions and/or positioning modalities, and utilizing the captured images and sensory input for mapping user selected work product entry location at the monitor viewing screen and/or performing other functions.

### RELATED APPLICATION

This application is a Continuation of now pending U.S. patent application Ser. No. 13/694,465 filed Dec. 5, 2012 by the inventor herein.

### FIELD OF THE INVENTION

This invention relates to devices and methods for controlling computer operations and, more particularly, relates to image and sensory processing to facilitate human interface for work product entry and visual presentation control at a computer terminal.

### BACKGROUND OF THE INVENTION

People working on computers and laptops having a visual display (monitor) use various control mechanisms such as a keyboard, mouse, trackball, slide pad or the like for data (work product) entry and/or visual display control (such systems or parts thereof in combination hereinafter referred to as a “computer terminal”). Keyboards have a key-field arranged along X and Z axes and are widely used for, among other things, word processing and other data entry functions and navigation. Use of a mouse or similar such device, however, in its most common (i.e., hardware) implementations, requires continual movement of the user's hand from the keyboard to the device and back since selection of menus, changing applications, scrolling, moving windows, repositioning the cursor, resizing windows and the like all require use of such devices. This constant separation of the user's hands from the computer keyboard is well known to be highly inefficient for a user, requiring constant repositioning of hands at a primary data entry tool such as the keyboard (and frequent backtracking to correct entry errors due to hand repositioning error).

Productivity can be further diminished merely by the constant mouse use of such devices and is often significant. These devices must be maintained (cleaned and, where batteries are required, dismantled) and carried separately if desired for travel. Use of such devices is wasteful of work area space and often requires users to deploy and monitor multiple touch base devices at one time.

Means have been suggested for vision based tracking of various types (see, for example, U.S. Patent Application Publications 2011/0006991 and 2011/0102570). Such means, however, are often quite cumbersome requiring multiple cameras and/or have not proven to provide completely accurate cursor placement in the monitor screen display.

There has been found to be some difficulty inherent in trying to map video images to cursor positioning at a monitor screen (a simple mapping of video captured finger movement to cursor positioning, for example). The standard mouse is typically a device relying completely on relative positioning (i.e., mouse movement to the right results in cursor movement to the right). If the mouse hits the edge of the work surface before the cursor hits the selected target, the user simply picks up the mouse and puts it down where there is more space and continues. This type of relative operation has heretofore not proven effective for video imaging based tracking.

Moreover, typically webcam resolution is smaller than a computer monitor screen resolution. For example current non-HD webcam pixel resolution might be 640×480 while a single computer monitor size of 1920×1200 pixels is common. Thus, if one were to use direct finger movement to control monitor screen location via a camera image, the cursor would jump three pixels at a time across the screen, and there would be no way to get the cursor into every location on the screen. The picture gets even more complicated in a multiple monitor scenario where twice the problem is presented for a two screen monitoring setup. Additionally, for various reasons human fingers vibrate and shake. This limits the ability to provide precise control using vision based tracking of finger movement, since accurate interpretation of finger position and movement is required to achieve desired screen location and function.

Further development and improvements directed to camera-based cursor positioning and monitor screen function control systems could thus still be utilized.

### SUMMARY OF THE INVENTION

This invention provides apparatus and methods for image and/or sensory input processing for user control of computer input operations, and may be thought of as a type of enhanced computer mouse. Digit (i.e., finger and/or thumb) movements are used for image and sensory input to control certain computer operations including monitor screen pointer control. Apparatus associated with a computer keyboard having a data entry key-field arranged along X and Z axes is provided, the apparatus to facilitate user interface for work product entry and visual presentation control at a computer terminal including a CPU, monitor and the keyboard utilizing image capture of movement above the keyboard primarily in X and Y axes relative to the key-field.

The apparatus and methods of this invention allow a user to maintain hand/finger positioning at the computer keyboard while yet controlling computer monitor screen pointer positioning and selected screen/program functions. The apparatus and methods improve user efficiency and productivity, reduce or eliminate certain maintenance requirements, are easier to use and transport, are compact, and require no additional work surface space. The apparatus and methods of this invention provide highly accurate and intuitive monitor screen pointer positioning and movement, while allowing for imprecision based on involuntary user hand/finger movement of various types.

The apparatus of this invention is associated with a computer keyboard having a data entry key-field plane along X and Z axes and is deployed to facilitate user interface for work product entry and visual presentation control at a computer terminal including a CPU, a monitor and the keyboard. The apparatus includes a camera adapted for capturing images of movement above the keyboard primarily in an image plane along X and Y axes substantially normal to the key-field plane. A touch pad segment is located at the keyboard opposite the key-field from the camera. A controller is in communication with outputs of the camera and the touch pad segment for processing received signals indicative of captured camera images and received signals indicative of user touch pad segment contact and contact release, and responsive thereto sending control signals to the computer terminal CPU indicative of user selected work product entry location, tasks and monitor visual presentation control.

The methods of this invention for image capture and processing include the steps of capturing video images of movement above the keyboard primarily in an image plane substantially normal to the key-field plane and utilizing the captured images for mapping user selected work product entry location at the monitor viewing screen. Sensory input indicative of the user's selection of a function may also be captured and utilized for mapping. The sensory input may also include selection of at least one of relative entry location positioning modality and absolute entry location positioning modality, wherein utilization of captured images and sensory input is according to selected modality.

More particularly, the methods of this invention may include capturing video images of user finger movement above the keyboard primarily in an image plane substantially normal to the key-field plane and capturing user initiated sensory input indicative of selection of one of plural positioning modalities. The captured images and sensory input are then used for mapping user selected work product entry location at the monitor viewing screen using the selected positioning modality.

It is therefore an object of this invention to provide apparatus and methods for image/sensory processing to control computer operations.

It is another object of this invention to provide improvements directed to camera-based monitor screen pointer, or cursor, positioning and screen function control.

It is still another object of this invention to provide apparatus and methods for image/sensory processing to control computer operations wherein finger and thumb movements are captured to control certain computer operations including monitor screen pointer control.

It is yet another object of this invention to provide apparatus and methods for image/sensory processing to control computer operations that allow a user to maintain hand/finger positioning at a computer keyboard while yet controlling computer monitor screen pointer positioning and selected screen/program functions.

It is still another object of this invention to provide apparatus and methods for image/sensory processing to control computer operations that improve user efficiency and productivity and that reduce or eliminate certain maintenance requirements.

It is still another object of this invention to provide apparatus for image/sensory processing to control computer operations that are easier to use and transport, are compact, and require no additional work surface space for usage.

It is another object of this invention to provide apparatus and methods for finger image and sensory processing to control computer operations that provide highly accurate and intuitive monitor screen pointer positioning and movement while allowing for imprecision based on involuntary user hand/finger movement of various types.

It is yet another object of this invention to provide apparatus associated with a computer keyboard having a data entry key-field arranged along X and Z axes, the apparatus to facilitate user interface for work product entry and visual presentation control at a computer terminal including a CPU, monitor and the keyboard utilizing image capture of movement above the keyboard primarily in X and Y axes relative to the key-field.

It is another object of this invention to provide a method to facilitate user interface for work product entry and visual presentation control at a computer terminal including a CPU, a monitor having a viewing screen, and a keyboard having a data entry key-field plane along X and Z axes, the method including the steps of capturing video images of movement above the keyboard primarily in an image plane substantially normal to the key-field plane and utilizing the captured images for mapping user selected work product entry location at the monitor viewing screen.

It is yet another object of this invention to provide a method for image input and sensory input capture and processing that includes the steps of capturing video images of finger movement above a keyboard key-field plane, capturing sensory pad input indicative of the user's selection of at least one of relative entry location positioning modality and absolute entry location positioning modality, and utilizing captured images and sensory input for mapping user selected work product entry location at the monitor viewing screen according to selected modality.

It is still another object of this invention to provide a method to facilitate user interface for work product entry and visual presentation control using user hand and digit movements at a computer terminal including a CPU, a monitor having a viewing screen, and a keyboard having a data entry key-field plane along X and Z axes, the method including the steps of positioning a camera viewing slightly upwardly from a position adjacent to the key-field plane to capture view an image plane in X and Y axes and capture images of movement of the user hand and finger movements in the image plane, and utilizing the captured images of user hand and finger movements in the image plane for mapping user selected work product entry location to the monitor viewing screen.

It is yet another object of this invention to provide a method of image and sensory processing to facilitate human interface using user hand and finger movements for work product entry control at a computer terminal including a CPU, a monitor having a viewing screen, and a keyboard having a data entry key-field plane along X and Z axes, the method including the steps of viewing slightly upwardly from a position adjacent to the key-field plane to capture video images of an image plane in X and Y axes and images of movement of the user hand and finger movements in the image plane, capturing user initiated sensory input indicative of selection of one of plural positioning modalities, and utilizing captured images and sensory input for mapping user selected work product entry location at the monitor viewing screen using the selected positioning modality.

It is another object of this invention to provide apparatus associated with a computer cpu and keyboard, the keyboard having a data entry key-field plane along X and Z axes with multiple keys arrayed across a keyboard surface defined by the key-field plane, the apparatus to facilitate user interface for work product position entry and visual presentation control including cursor location at a computer monitor associated with the keyboard by capture of images and sensory input of user hand and finger movements for mapping user selected work product entry location and presentation control at the monitor, the apparatus including at least a first camera adapted for selected positioning adjacent to the keyboard surface and aimed slightly upwards relative to the surface towards a position where the user hand and fingers can be viewed in an image plane primarily along X and Y axes substantially normal to the key-field plane to capture images of the image plane including user finger movements and position in the image plane above the keyboard and having an image output for output of signals indicative of captured images, at least a first touch pad segment located at the keyboard opposite the key-field from the camera and having a contact output for output of signals indicative of user contact and contact release, and a controller in communication with the outputs of the camera and the touch pad segment for processing the signals and responsive thereto sending control signals to the computer CPU indicative of user selected work product entry location, tasks and monitor visual presentation control including mapping finger movements in the image plane to cursor location at the computer monitor.

With these and other objects in view, which will become apparent to one skilled in the art as the description proceeds, this invention resides in the novel construction, combination, and arrangement of parts and methods substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a perspective view illustration showing the apparatus of this invention in conjunction with a standard computer keyboard;

FIG. 2 is a block diagram illustrating interconnection of the components of the apparatus of this invention;

FIG. 3 is a flowchart illustrating a preferred embodiment of the control methods of this invention;

FIG. 4 is a flowchart illustrating finger identification over time operations of the preferred embodiment of the control methods of this invention;

FIG. 5 is a flowchart illustrating gesture matching operations of the preferred embodiment of the control methods of this invention; and

FIG. 6 is a flowchart illustrating absolute and relative positioning operations of the preferred embodiment of the control methods of this invention.

### DESCRIPTION OF THE INVENTION

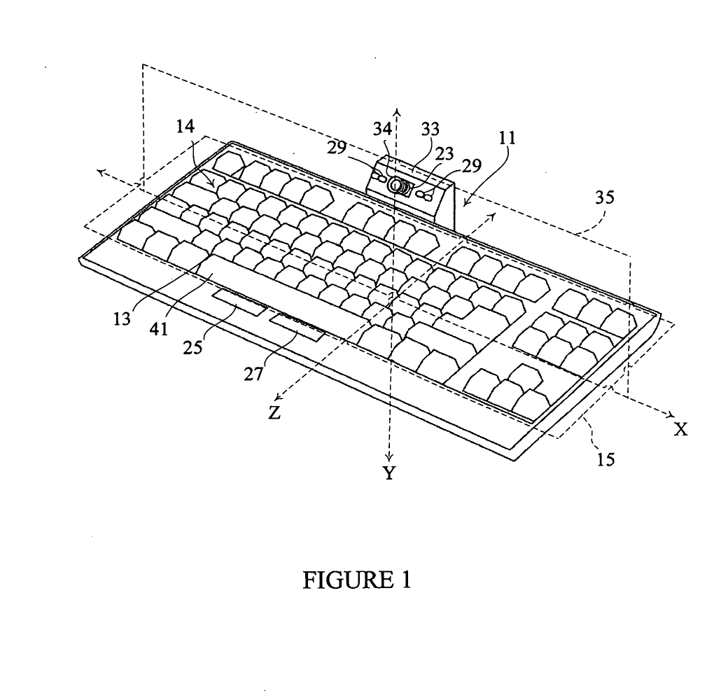

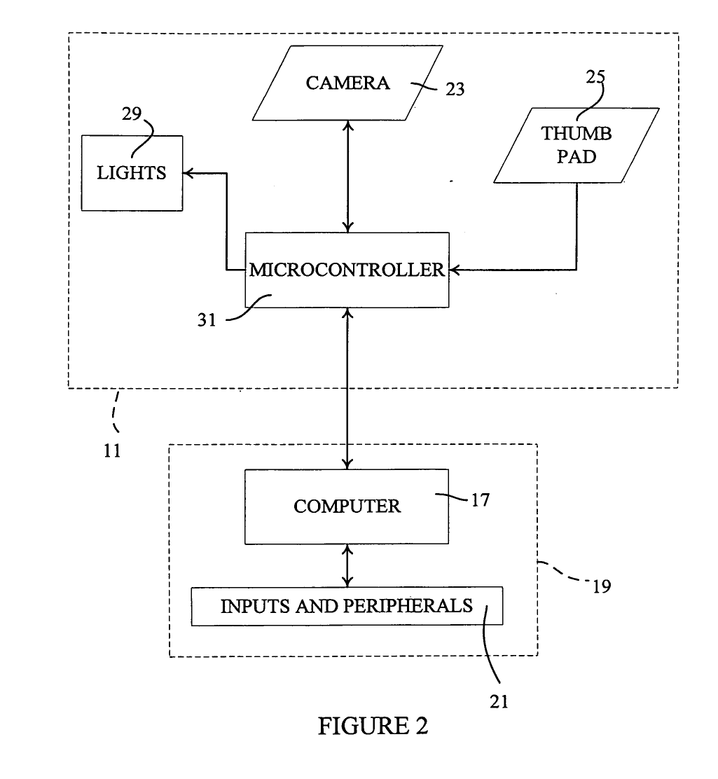

FIGS. 1 and 2 illustrate apparatus 11 of this invention associated with a computer keyboard 13 having a data entry key-field 14 in key-field plane 15 along X and Z axes. Apparatus 11 may be thought of as providing enhanced mouse-type device functionality, facilitating user interface with computer 17 for work product entry and visual presentation control at a computer terminal 19 including the computer (CPU) 17, and inputs and peripherals 21 such as a standard monitor having a viewing screen, keyboard 13, and the like. Apparatus 11 preferably includes at least a first video camera 23 providing image input and at least a first touch pad segment 25 providing sensory input (and even more preferably left and right touch pad segments 25 and 27 which may be either separate pads or sections of a single pad with selected section functionality defined in software, in either case hereinafter knows as pad segments). Infrared (IR) illumination devices 29 and controller (a microcontroller) 31 housed, for example, in mount/housing 33 complete the preferred mode of apparatus 11.

Microcontroller 31 utilizes captured images and captured sensory input for mapping user selected work product entry location at the monitor viewing screen and can be located at any known substrate, with connections and component mounting utilizing wire, ribbon cable, flexible circuit boards or other flexible substrate being common. Microcontroller 31 organizes and controls image processing of video camera 23, the illumination devices 29 (brightness and on/off), and touch pad segments 25/27 input. Microcontroller 31 is preferably represented to the computer as one device. The software which performs the analysis of image processing, including digit (primarily finger(s)) detection, gesture detection, and other functions, can be entirely resident at controller 31 or can be shared between CPU 17 and controller 31. Because processing of images can be quite processor intensive, allowing microcontroller 31 to perform some or all of these computations can reduce the stress on CPU 17's core and place more of the resource demand onto apparatus 11. The firmware at controller 31 is updatable from CPU 17, making software enhancements readily available, downloadable and applicable by the end user.

Camera 23 includes wide angle lens 34. Any known type of video camera may be used with apparatus 11. Standard webcam-type devices, however, have been found to be sufficient and economical. Camera 23 streams video images to microcontroller 31 where they are constantly recorded and processed with input from touch pad segments 25 and/or 27 to provide a data stream to computer 17 utilized for selected computer terminal control and operations. Camera 23 is adapted for location and orientation at keyboard 13 to capture images of movement above keyboard 13 primarily in image plane 35 along X and Y axes substantially normal to key-field plane 15. Output from camera 23 provides signals indicative of captured images at controller 31.

Touch pad segment(s) 25(27) are located at keyboard 13 opposite key-field 14 from camera 23. Alternatively, the pad segment(s) could be incorporated into a spacebar provided with capacitive touch recognition and appropriate programming. Since a spacebar is merely a switch on the keyboard activating the computer to place a space at the cursor's position, a tactile or capacitance sensor could be added to the surface of the spacebar. The touching of the spacebar with the thumb, without the spacebar actually being depressed, would then activate apparatus 11. If the spacebar were not used within a selected amount of time the software of apparatus 11 could consider this an activation of the apparatus 11. Sliding the thumb across the spacebar, tapping it, and positioning the thumb along the spacebar would all provide the same logic/functionality as separate touchpad segment(s) 25(27) behind the spacebar as described hereinbelow.

Each pad has an output providing signals indicative of sensory input related to user contact and contact release at pad(s) 25(27) at controller 31. Controller 31 processes the signals as discussed hereinbelow, and responsive thereto sends control signals to computer 17 indicative of user selected work product entry location, tasks and monitor visual presentation control (using a USB or alternative such connection(s)). Computer 17 utilizes these control signals in accord with its normal programming.

Video camera 23 is aimed slightly upward towards a position where the users' hand can be viewed in image plane 35. Pad segments 25/27 are, in one embodiment, preferably placed slightly behind keyboard spacebar 41. Programming at controller 31 reads input from video camera 23 and pad segments 25/27 and uses the input from both for user navigation and control input to CPU 17. Using the apparatus of this invention, a user can point up to the right or left without taking hands off keyboard 13 to cause mouse pointer movement, pan, scroll, zoom, and the like, for example, at a computer peripheral 21 monitor screen of computer terminal 19, either alone or in combination with thumb contact with pad segments 25/27. Camera 23 placement records hand/digit (finger) movement primarily in image plane 35 substantially normal to key-field plane 15 in the X axis (from side to side across keyboard 13) and the Y axis (toward and away from keyboard 13), with some limited Z axis finger movement (from keyboard top to keyboard bottom) captured due to the cameras angular orientation relative to key-field 14.

Camera 23 location is preferably at the center of key-field 14 or slightly to left thereof centered on the QWERTY keyboard section. Wide angle lens 34 allows camera 23 to capture at least the area above the keyboard area where the hands sit at rest and cover at least the x axis range from the letter A on the left to the semicolon on the right. This keyboard area camera coverage has been found to be sufficient for most common applications, though different coverage conventions could be employed as necessary for the particular use and user.

Mount/housing 33 preferably includes structure for holding camera 23 and IR illumination devices 29 (LED or lamps, for example). Mount/housing 33 will preferably allow the camera to be folded into a smaller space when not in use, for example at a laptop case. This will also allow use where keyboard drawers are in place, so that the drawers can still be closed. The design preferably will allow video camera 23 to be folded back, tilting it 90 degrees, so it recesses into its case, and causing return upon reopening to its originally set position. Since camera 23 and its mounting angle can be adjusted to different keyboards, a calibration at time of installation is performed. Thus it is preferable that camera 23 always point to the same location to avoid the need for recalibration. As may be appreciated, there are many possible designs appropriate for mounting and housing that include video camera retractability and precision redeployment. Additional considerations for mounting include allowance for camera matching with particular keyboard position and size. Keyboards, including taller keyboards pointing at an angle, must all have means for connection of mount/housing 33 such that movement of the keyboard will facilitate camera movement with it.

The Infrared LED's 29 are preferably positioned at mount/housing 33 at both sides of camera 23 to help illuminate the hands/fingers off the keyboard to thus provide maximized functionality in any lighting situation. This allows vision during hours where very little ambient light is available, but more importantly improves the camera's and software's ability to easily identify objects close up while rejecting objects in the distance (since distant objects would not be lit with the same intensity). IR devices 29 are electronically connected so that brightness/intensity are adjustable via software at microcontroller 31 to better allow the identification of fingers quickly with less processing power.

It should be appreciated that keyboard 13 could be programmed (where allowed) to include the functionalities discussed hereinbelow for touch pad segments 25/27. However, touch pad segments 25/27, touch sensitive grids also known as tactile feedback pads or sliders, are preferred and are positioned so that each is accessible by a different one of the left and right thumbs of the user. Alternatively one long grid could be deployed. Known such pads include variable potentiometers, capacitive touch sensors, or alternative mechanisms. As deployed herein, pad segments 25/27 will register the thumbs' location along a pad in the X axis and read shifting of a thumb in contact therewith from side to side. Pad segments 25/27 also register thumb taps thereon (i.e., in a single, double or triple tap or click pattern commonly understood by most users and utilized in most mouse software). Touch pad(s) 25(27) is utilized also to activate apparatus 11 by touching the pad, and to control various other features and operations using additional pad tap or touch/hold location feedback during the user's operation of apparatus 11. If pad segments 25/27 cannot be placed on a particular existing keyboard, a secondary mounting bracket to hold them may be provided.

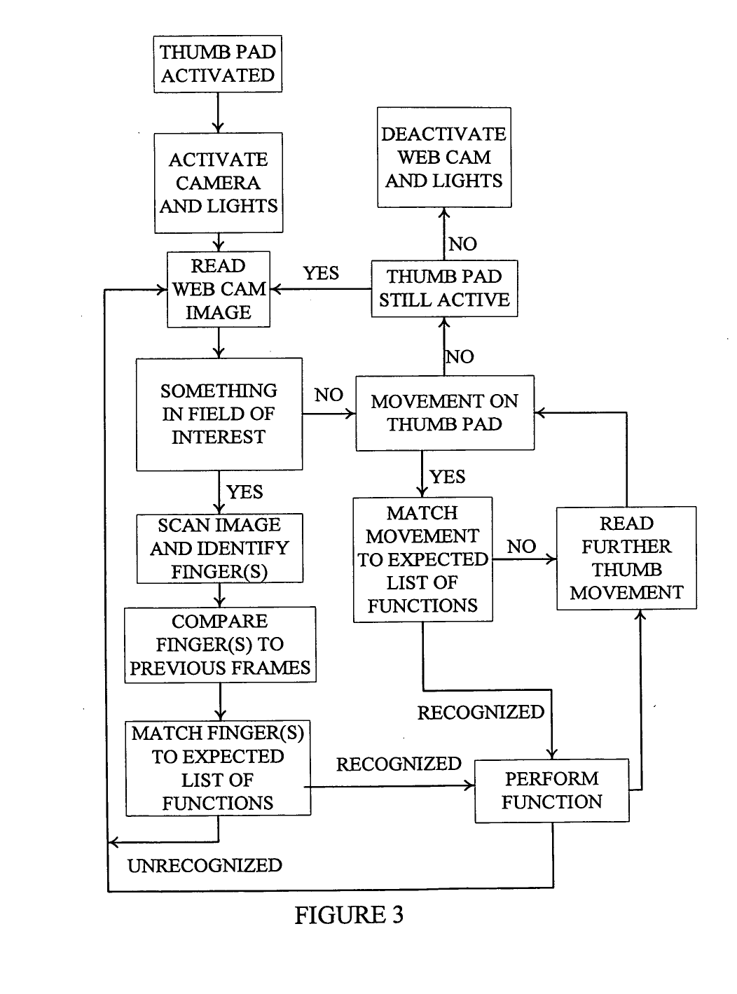

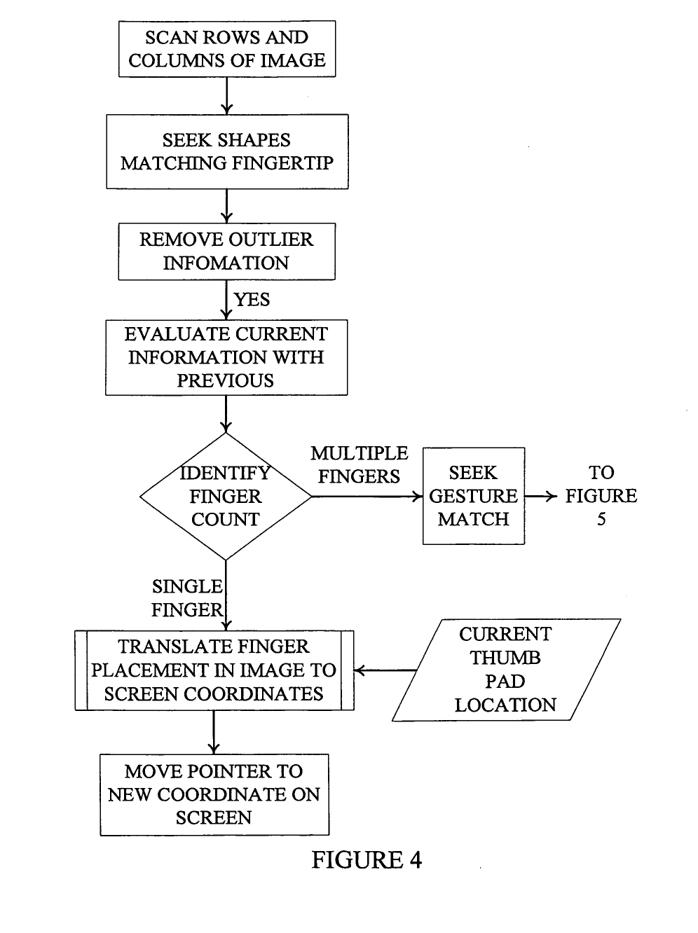

FIGS. 3 through 6 illustrate the methods and program control of this invention for image/sensory input processing and function selection and interpretation. Turning first to FIG. 3, a user activates apparatus 11 by contacting (or pressing) the thumb touch pad 25 or 27. While pressure is maintained on the pad (a typical mouse-type hold function), controller 31 will activate lighting devices 29 and camera 23 and begin to read images from the camera 23. Each image frame is read, and controller 31 software analyzes the positions of the user's fingers in image plane 35 when present. If a single finger is pointing up for example (typically the first finger on either hand), the software will translate the location of the finger in the image to the mouse pointer location on the monitor screen of computer terminal peripheral 21 as discussed hereinbelow (see FIG. 4). As the user moves the finger to the right, left, up or down the mouse pointer location on the monitor screen will move accordingly, the mouse pointer on the computer screen following finger movement. In a simple sense, the user is pointing to where he/she wants the pointer/cursor to move on the screen.

Once the user moves the cursor to the desired position, release, recontact and re-release of thumb contact with pad segment 25 or 27 creates a single tap which will cause performance of a typical mouse-type left click function. This series of release, recontact and re-release can be repeated as necessary for typical mouse-type double or triple click operations. Alternatively, the user can quickly release and recontact the thumb touch pad segment and then hold the thumb in contact with the pad, causing performance of functions relating to typical left or right mouse-type button hold operations (for example, drag and drop operations). This is also useful for moving windows, selecting and moving text, resizing, opening menus, and the like. Where thumb pad activity ceases completely for a selected period of time (preferably selectable in software setup), apparatus 11 is deactivated.

As may be appreciated, the user can thus maintain palm contact on the keyboard base and can keep all non-pointing fingers at rest in a neutral typing position. This allows a user to be more efficient (not having to reposition fingers at the keyboard repeatedly) while also achieving movement stability at image plane 35 thereby improving mouse pointer location and function control. Digits of both hands can be recorded by camera 23 in image plane 35, and multiple fingers used together as well as gestures of the hands in image plane 35 can be read and interpreted in software. Touch pad segments 25/27 can not only be used to contact, hold and tap, but can also be read for shifting of the thumbs from side to side as well as for amount of pressure exerted downward by the thumbs, thereby allowing programming of additional functions. Since apparatus 11 recognizes both hands individually and together in the image plane, and has thumb touch pad segments on both sides, either hand can be used for a particular function allowing both right and left handed individuals the same control routines. Alternatively, left and right hand and pad functionality can be separate and addressed to different functions, thereby expanding the number of functions and operations controllable by apparatus 11.

Based on the process described and shown in FIGS. 3 and 4, FIGS. 4 and 5 illustrate how gesture matches are accomplished to perform the following examples of functions by a user at apparatus 11 without ever removing hands from keyboard 13 or eyes from the peripheral 21 monitor screen. As a group these are identified as “functions” in the drawings, and the actual mechanisms for performing the functions will be interchangeable in many cases. Moreover, while some functions are described hereinafter as examples, a great many other functions could be accommodated in programming, user preferences settings, and/or through user-driven learn-mode functionality.

For example, when the monitor screen pointer is moved to a desired location and the thumb touch pad pressed, a finger moved in image plane 35 selects text or draws a rectangle around selected graphics. When the end point of the selection is found, the thumb is released which will cause the data to be selected. The selected data can then be further manipulated. Multiple fingers (3 or 4 fingers) can be pointed up and to the right in image plane 35 and thumb pad 25 or 27 pressed and held down while the fingers are moved from right to left in image plane 35 causing the application or window to be panned (or scrolled) to the right. The touch pad can be released while the fingers are moving and the scroll will be decelerated. If the fingers are not moving, the scroll will be stopped immediately. The scrolling can be done in any direction (up, down or left, right) and simulates the feel of many known portable touch devices.

Because this type of scrolling may be difficult for some to coordinate, an alternative method can be used by holding a thumb pad segment 25/27 down, and rotating the hand clockwise or counter clockwise in image filed 35. The right hand going in circles will cause horizontal panning, and the left hand rotation will cause vertical scrolling. Alternatively, thumb pad segments 25/27 can be used as scroll devices on their own. If no fingers are up, a thumb can press on touch pad segment 25 or 27 on one side and then be slid across the pad to the other side causing a horizontal pan in the selected direction. Reversing the slide would cause pan in the opposite direction. The alternate thumb can then be used on the other pad for vertical scrolling.

Repositioning of active window function can be user initiated by pointing two fingers of one hand up in image plane 35 and pressing a thumb pad 25/27. As the user then shifts finger point direction the window will shift, following that motion. Once the window is in the desired location the thumb is lifted off pad 25/27. Window minimizing can be accomplished similarly with a quick downward finger motion. Window resizing function utilizing these same motions, with a pad segment 25 or 27 zoned so that the left half causes the window to be moved and the right half causes the window to be resized. Zooming functions are accommodated when the first fingers on each hand are pointed up into image plane 35 and thumb touch pad segment 25 or 27 is pressed. Moving the fingers in opposite directions away from each other in image plane 35 causes zoom out while moving the fingers together towards each other causes zoom in. Alternatively, touch pad segments 25 and 27 could be programmed for simultaneous use to cause zooming in and out (by sliding thumbs together or apart on pad segments 25 and 27).

Functions related to closing and opening of applications are initiated by pointing a hand up with all fingers splayed in image plane 35, depressing thumb touch pad 25 or 27, and squeezing the fingers together to a common point (application closing). A reverse process causes application opening. Drawing or painting functions in a drawing application are manipulated by pressing thumb touch pad segment 25 or 27 while one or multiple fingers are used in image plane 35 to draw or paint across the screen. In this function thumb touch pad segments 25 and 27 can be used in various ways, for example to thicken paint brush size, erase, change colors and the like. 3D software (Cad, for example) positioning functions require use of both hands along with thumb pads for navigation and implementation of assorted options. Other specialty programs can be similarly controlled with appropriate programming.

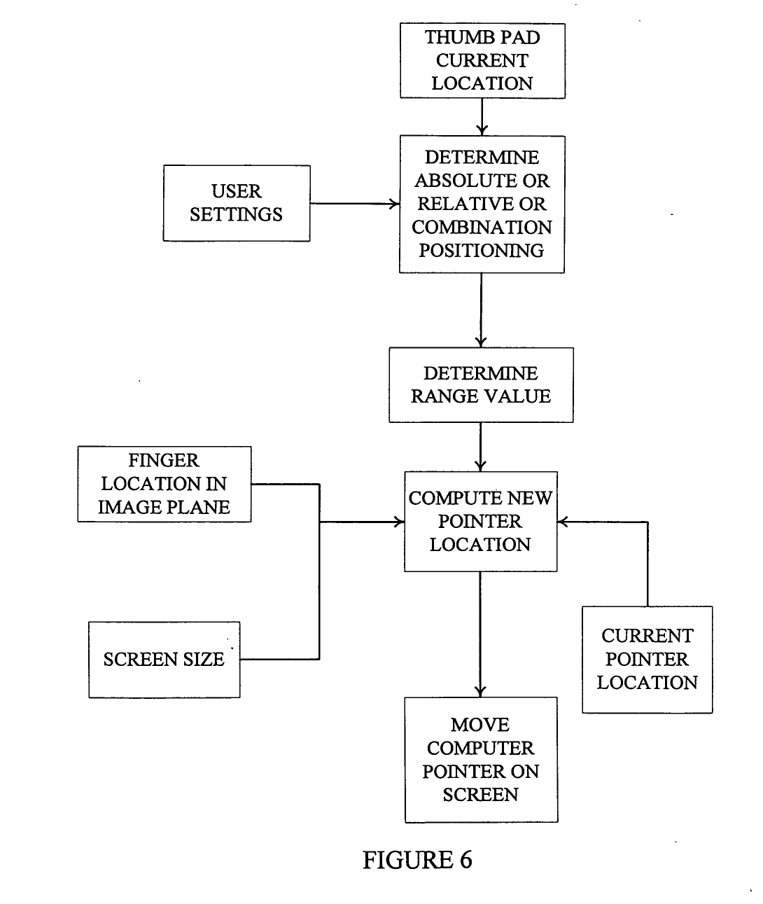

Software programming at controller 31 uses image (camera 23) and sensory (thumb pad segments 25/27) information and combines that information into usable tools. The software program must first analyze images it reads, thumb touch pad information it receives, interpret them as identifiable finger and and/or thumb activity combinations, relate these to functions, and finally to computer operations. As shown in FIG. 3, activation of a touch pad segment 25/27 will activate the entire device. The location of thumb placement along a pad segment 25 or 27 will dictate how cursor positioning happens. For example, if the touch pad is activated on the left side (assuming user preference), positioning will occur as an absolute pointer location process, while if the same touch pad segment 25 or 27 is activated on the right positioning will occur as a relative pointer location process (as described hereinbelow with respect to FIG. 6). Any such positioning can be reversed of altered, together with other program values and functions, in microprocessor programming.

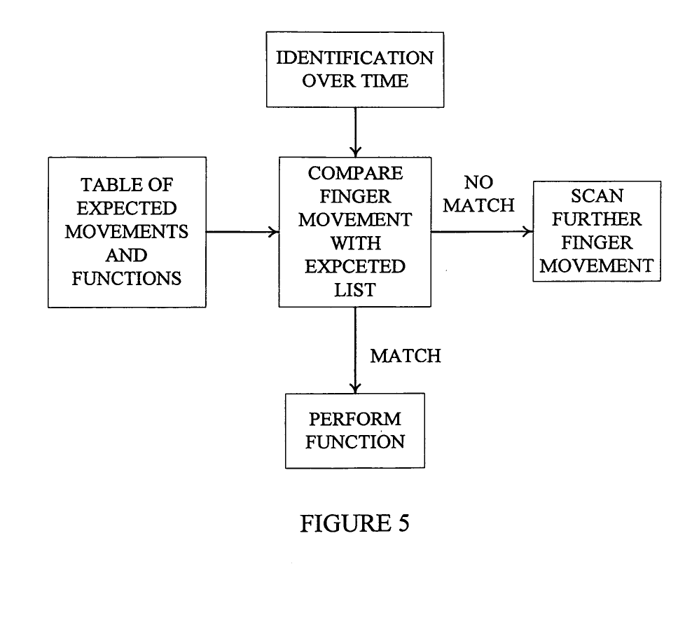

Translating images received to finger combinations (FIG. 4) by comparison to previous frames is accomplished by reading the image in image plane 35 pixel row by pixel row and pixel column by pixel column. Based on appropriate algorithms as identified in FIG. 4, potential finger locations and counts will be identified and targeted. These data are then translated to functions by comparison to a functions list. If a single finger is active, the translation will be direct to the mouse location following the relative/absolute positioning options and formulas set out below. If multiple fingers are identified, the software will track the finger movement and record history (FIG. 5). This history will be reviewed together with known movement patterns to identify gestures. Once a gesture is identified in combination with the thumb touch pad options (holds and/or clicks, for example—see FIG. 3) a function is selected to execute. Any selected function must then be translated into output indicative of a desired computer operation to be performed at terminal 19 that is identifiable by and/or further processed in programming at CPU 17.

Turning now to FIG. 6, as noted there are some difficulties to overcome with a simple mapping of finger position in the X/Y coordinate image plane 35 to cursor/pointer positioning on the monitor screen (differences in pixel resolution and instability of user finger movements and thus image presentation being primary among them); The methods of this invention address these difficulties by providing for user implementation of plural positioning modalities. Two different monitor pointer positioning modalities, absolute and relative, are provided during position location operations, and these are usable either alone or in concert. Touch pad segments 25 and 27 each have zones identified with the left and right side of each pad segment. This allows user selection of either relative or absolute image positioning, or both, depending on thumb location selected on the pad segment. Shifting the thumb across the pad allows a user to rapidly control the positioning modality, as well as monitor pointer positioning accuracy. In a relative positioning process, impacts to imaging of finger shaking can be reduced by allowing the user to quickly change the level of relativism (by sliding the thumb in one zone on the pad segment). For example, if the thumb is on the left side of a pad segment 25 or 27 the mouse pointer software will operate in absolute positioning modality so that if the user points to the top left of the screen the mouse will go directly there. If the thumb is pressed on the right side of the same touch pad segment 25/27 the mouse pointer software operates in relative positioning modality and will move in smaller relative positioning amounts for fine locational control. This combination overcomes the limitation in accuracy of hand movements and their mapping to computer monitor screen positions which of necessity requires some accuracy of input.

User settings allow a user to select options like zones, or areas, in the selected touch pad segment or pad segments where thumb positioning will cause absolute positioning modality employment, areas in the touch pad segment or pad segments that will cause relative positioning modality employment, and/or some combination thereof, as well as various sensitivity (range) settings. Using the above example, where the left side of a touch pad is used for controlling absolute positioning variables and the right half for controlling relative positioning variables, each of those left half and right half zones will in addition be assigned a range value (i.e., 1 to 1000 depending on thumb location along the selected zone). In this way, when the user presses on the touch pad thus programmed by the user, the primary information passed to the controller software is thumb zone location/positioning modality type (relative, absolute, or a combination at a center position, for example) and thumb position location in the determined type-zone/range value (for example, a value between 1 and 1000).

In absolute positioning modality, the range of finger movement is established either during calibration or by actively monitoring and recording the user's positioning while using the device (a learn mode). This range is set from the user's pointing area from its most left in image plane 35 to its most right (X axis), and most up in image plane 35 to most down (Y axis), forming a four sided trapezoidal image plane that the finger moves in. This range is then translated to the computer monitor screen rectangle area. For example, if a user thumb location in a pad zone indicates a 100% absolute positioning (when the range value of the thumb location is 1000), when the finger points to the most top left area in the established video camera range the cursor pointer would go to the top left monitor screen position. If the finger points to the most bottom right area in the video camera trapezoidal image plane, then the monitor pointer would point to the most bottom right area of the monitor screen.

If the user thumb location on the absolute positioning modality pad segment zone indicates a less than 100% absolute positioning, the percentage would be applied to the monitor screen area relative to the position of the fingers in the trapezoidal image plane, so that the potential area that the pointer could be positioned in is reduced to that percentage. So, for example, if thumb location indicates a value of 50%, then the monitor screen area that could be navigated would be one half, based on the current position of the cursor on the monitor screen. In such case, if the user moves his/her finger in the image plane from most left to most right, the monitor screen pointer will only navigate half the screen area from left to right of the current cursor position. The same applies to finger movement in the Y axis of the image plane. As the percentage is reduced by movement of the thumb along the given pad segment zone, the area of the monitor screen movement would be reduced, allowing a higher level of accuracy of movement as a larger area of finger movement translates to ever smaller areas of monitor screen pointer movement.

Relative positioning modality as utilized herein is similar to how movement/positioning occurs using a traditional mouse. A shift from left to right of the finger in the image plane causes the pointer to shift from left to right. The same applies to finger movement in the Y axis of the image plane. The range value as determined by thumb location along the relative positioning modality zone is used to translate between a given number of pixels of finger movement in video camera image plane 35 and monitor pointer movement amount (computer monitor screen pixels equivalent).

If the relative positioning range value as identified by thumb position in the selected relative positioning modality zone of a pad segment 25/27 is 1000 (maximum), the maximum user chosen number of screen pixels per camera pixel is traversed according to finger movement in image plane 35. User selection of maximums may be accommodated in apparatus set-up settings. If, for example, the user selected maximum relative positioning traversal is 20 pixels, when the finger movement in image plane 35 is determined to be one pixel in a selected direction the pointer on the monitor screen would traverse 20 pixels in the selected direction. If the relative position range value is reduced by sliding the thumb along the relative positioning modality zone of the touch pad segment 25 or 27 (for example, to 500), then the monitor screen pointer traverses a reduced amount (half of the user selected setting in the example, or 10 pixels) for each pixel of finger movement in image plane 35. In this way, finger movement is provided a higher level of control accuracy for the user to position the monitor screen pointer at any desired location.

The user's ability to quickly relocate his/her thumb in coordination with the settings and position of the finger being pointed, allows for quick navigation to desired monitor screen positions. It should be recognized that a combination of these two values will often be used (i.e., software driven). Additional computations using the acceleration of the finger and application being used can allow an auto detection of relative versus absolute positioning, providing yet another option to allow apparatus 11 software to determine a user's desired modality at an active rate while movement is occurring.

Since apparatus 11 and the associated software will be able to identify and track multiple fingers in image plane 35, a learn modality in the software (at CPU 17 and/or microcontroller 31) can be implemented for user activation of a recording routine whereby finger movement over time can be recorded and assigned a function by a user. For example, software will be able to identify when the right hand is showing four fingers pointing towards the screen. If a user records the motion of those four fingers moving up or down simultaneously, the movement recorded can be assigned a function with that function further assigned to a computer function (such as “close window” or “close application” or the like). Other examples of this might be both hands closing at the same time translating to a shutdown operation on the computer, or clapping (touching hands together) assigned to open a music program. It should be understood that any computer functionality capable of assignment can be assigned to movements (identifiable as either image or sensory input) by apparatus 11.

As may be appreciated from the foregoing methods and apparatus for improved computer control are provided that are especially well adapted to image and sensory processing facilitating improved user interface for work product entry and visual presentation control at a computer terminal. Alternative or additional mechanisms and control variations can be utilized herein as may be appreciated by those skilled in the art. For example, the touch sensitive grids may be replaced by various software operations in combination with the video camera, depending on accuracy requirements. The video camera could, in such case, be utilized to identify thumb positions and software utilized to translate those positions and movement into the same signal information to be received by the touch sensitive pad segments.

Filters could be applied at the lens of camera 23 to assist in the process of reading the images desired. For example, since image information from behind the user's fingers is not useful, nor is such information from beyond the edge of the keyboard, IR pass filters (only allowing IR wavelength information to enter the camera) and/or focus filters (to defocus information past the focal length set for the desired image plane) may be usefully deployed. An additional video camera 23 may be add added spaced from the first camera along the X axis providing separate imaging for the left and right hands and/or providing stereoscopic imaging allowing better use of image data from the Z axis. The primary purpose would be to increase the resolution, since each webcam would have its own CMOS sensor, effectively doubling the density/pixel resolution. Analysis of the two cameras together in a stereo process, moreover, would provide additional Z axis information which may be used in a variety of ways to enhance further computer control functions.

What is claimed is:

1. A method to facilitate user interface for work product entry and visual presentation control using user hand and digit movements at a computer terminal including a CPU, a monitor having a viewing screen, and a keyboard having a data entry key-field plane along X and Z axes, said method comprising the steps of:
positioning a camera viewing slightly upwardly from a position adjacent to the key-field plane to capture view an image plane in X and Y axes and capture images of movement of the user hand and finger movements in the image plane; and
utilizing the captured images of user hand and finger movements in the image plane for mapping user selected work product entry location to the monitor viewing screen.

2. The method of claim 1 wherein the movement is user digit movement, the method further comprising the steps of capturing sensory input indicative of the user's selection of a function and utilizing the captured sensory input with the captured video images for mapping user selected work product entry location at the monitor viewing screen.

3. The method of claim 2 further comprising the step of utilizing the captured images and sensory input for user selection of at least one of work product entry tasks and monitor visual presentation control.

4. The method of claim 2 wherein the step of capturing sensory input includes utilization of input generated by user thumb contact at a tactile feedback pad segment located at the key-field plane indicative of either of mouse-type click and mouse-type hold functions.

5. The method of claim 2 further comprising the step of utilizing at least one of captured video images and sensory input to perform functions including at least some of selecting text or graphics, monitor screen scrolling, monitor screen panning, window repositioning, window resizing, zooming, opening or closing applications, drawing, painting, and 3D software navigation and positioning.

6. The method of claim 2 wherein the step of capturing sensory input includes utilization of input generated by user thumb contact at either left and right tactile feedback segments located at the key-field plane.

7. The method of claim 2 wherein the step of capturing sensory input includes selection of at least one of relative entry location positioning modality and absolute entry location positioning modality.

8. A method of image and sensory processing to facilitate human interface using user hand and finger movements for work product entry control at a computer terminal including a CPU, a monitor having a viewing screen, and a keyboard having a data entry key-field plane along X and Z axes, said method comprising the steps of:
viewing slightly upwardly from a position adjacent to the key-field plane to capture video images of an image plane in X and Y axes and images of movement of the user hand and finger movements in the image plane;
capturing user initiated sensory input indicative of selection of one of plural positioning modalities; and
utilizing captured images and sensory input for mapping user selected work product entry location at the monitor viewing screen using the selected positioning modality.

9. The method of claim 8 wherein the positioning modalities include absolute positioning modality and relative positioning modality, said absolute positioning modality establishing range of user finger movement and translating said range to the computer terminal monitor rectangular view area, said relative positioning modality utilizing up, down, left and right user finger movement in the image plane to move a cursor viewed on the monitor viewing screen.

10. The method of claim 8 wherein the step of capturing user initiated sensory input includes utilization of input generated by user thumb contact at a tactile feedback pad segment located at the key-field plane.

11. The method of claim 8 further comprising the step of capturing user initiated sensory input indicative of a range value of the selected positioning modality, said range value for translating between a given number of pixels of user finger movement in the image plane and monitor screen pixels equivalent.

12. The method of claim 8 further comprising the step of capturing user initiated sensory input indicative of a range value of the selected positioning modality wherein said range value is indicative of selected area of monitor screen that can be navigated.

13. The method of claim 12 wherein said value indicative of a selected area includes any of a maximum range value substantially relating finger movement area in said image plane to entire monitor screen area and plural range values relating said finger movement area to different monitor screen areas less than said entire monitor screen area.

14. The method of claim 8 wherein the step of utilizing captured images and sensory input further comprises processing said images and input and responsive thereto sending control signals to the computer terminal CPU indicative of user selected work product entry location, tasks and monitor visual presentation control.

15. The method of claim 8 further comprising the step of user selection of setting options establishing location of user initiated sensory inputs and values associated with user initiated sensory inputs.

16. Apparatus associated with a computer cpu and keyboard, the keyboard having a data entry key-field plane along X and Z axes with multiple keys arrayed across a keyboard surface defined by the key-field plane, said apparatus to facilitate user interface for work product position entry and visual presentation control including cursor location at a computer monitor associated with the keyboard by capture of images and sensory input of user hand and finger movements for mapping user selected work product entry location and presentation control at the monitor, said apparatus comprising:
at least a first camera adapted for selected positioning adjacent to the keyboard surface and aimed slightly upwards relative to the surface towards a position where the user hand and fingers can be viewed in an image plane primarily along X and Y axes substantially normal to the key-field plane to capture images of said image plane including user finger movements and position in said image plane above the keyboard and having an image output for output of signals indicative of captured images;
at least a first touch pad segment located at the keyboard opposite the key-field from said camera and having a contact output for output of signals indicative of user contact and contact release; and
a controller in communication with said outputs of said camera and said touch pad segment for processing said signals and responsive thereto sending control signals to the computer CPU indicative of user selected work product entry location, tasks and monitor visual presentation control including mapping finger movements in said image plane to cursor location at the computer monitor.

17. The apparatus of claim 16 wherein said camera is a video camera, said video camera including a wide angle lens, said apparatus further comprising infrared illumination devices associated with said video camera and connected with said controller, said video camera, said lens, said illumination devices and said controller being located together in a mount/housing.

18. The apparatus of claim 16 wherein said video camera is a webcam having at least one of an IR pass filter and a focus filter thereon.

19. The apparatus of claim 16 further comprising at least a second touch pad segment adjacent to said first touch pad segment.

20. The apparatus of claim 16 further comprising at least a second camera spaced from said first camera along the x axis for improved movement imaging.
